(19) United States
(12) Patent Application Publication
(10) Pub. No.: US 2021/0071994 A1
(43) Pub. Date: Mar. 11, 2021

(54) ADAPTIVE MOBILE CAMOUFLAGE SYSTEM

(71) Applicant: SAAB AB, Linkoeping (SE)

(72) Inventors: Daniel JACOBSSON, Gamleby (SE); Anders WIMAN, Vaestervik (SE)

(21) Appl. No.: 16/642,058

(22) PCT Filed: Aug. 30, 2018
(86) PCT No.: PCT/SE2018/050866

§ 371 Date: Feb. 26, 2020

(30) Foreign Application Priority Data
Aug. 30, 2017 (SE) 1751042-1

(51) Int. Cl. F41H 3/02

(52) U.S. Cl. CPC F41H 3/02

(57) ABSTRACT

The present invention relates to a mobile camouflage system (1) for camouflaging vehicles. The system comprises a base camouflage material (13) configured to be securely attached to a vehicle (5) to be camouflaged, and at least one adaptive camouflage area (7) having a camouflage pattern that can be adapted to a surrounding environment. The adaptive camouflage area (7) comprises a patch arrangement (10) having at least one patch (11, 12) that is movable between a first patch configuration in which the adaptive camouflage area (7) exhibits a first camouflage pattern, and at least a second patch configuration in which the adaptive camouflage area (7) exhibits a second camouflage pattern that is different than the first camouflage pattern.

### TECHNICAL FIELD

The present invention relates to a mobile camouflage system.

### BACKGROUND ART

Camouflage materials are generally designed to be adapted to a specific surrounding environment, such as a woodland landscape dominated by vegetation, a desert landscape dominated by sand, or a winter landscape dominated by snow and ice.

The purpose of the camouflage material is normally to break up the electromagnetic signature of the camouflaged object and to adapt the electromagnetic signature of the object to the signature of the surrounding environment, so as to avoid detection by the human eye and/or various sensors operating in different wavelength regions of the electromagnetic spectrum.

Camouflage systems can be roughly divided into two main categories; static camouflage systems for camouflaging objects in static positions, and mobile camouflage systems for camouflaging mobile objects, such as vehicles.

Static camouflage systems that are adaptable to different surrounding environments are known. For example, there are camouflage nets that have different colours on opposite sides, allowing the user to adapt the camouflage colour to different environments simply by reversing the camouflage net in relation to the object to be camouflaged.

A more sophisticated static camouflage system has been proposed in GB2420169A, which discloses a reversible camouflage net comprising a first net mesh having a first mesh dimension, and a second net mesh underlying the first net mesh and having a second mesh dimension that is smaller than the first mesh dimension. The first net mesh and/or the second net mesh can have different colours on opposite sides. The first net mesh is releasably attached to the second net mesh and by reversing the first net mesh in relation to the second net mesh the colour of the camouflage net can be adapted to different environments.

Another example of a reversible or invertible camouflage construction is disclosed in US2013/0040114A1. This invertible camouflage construction contains a base layer and a two sided garnish. The first side of the garnish includes a first pattern, and the second side of the garnish includes a second pattern that is visibly distinct from the first pattern. The base layer is attached to the garnish in a configuration that is adapted for allowing inversion of the base layer with the garnish to swap positions of the first pattern and the second pattern in relation to the base layer.

Due to the construction of the camouflage material and the way the camouflage material is inverted in order to change the pattern of the camouflage, none of the above described static camouflage systems is suitable for camouflaging mobile objects, such as vehicles.

A mobile camouflage system is often a complex camouflage system that must be tailored to the particular vehicle to be camouflaged so as not to adversely affect the operational performance of the vehicle. A mobile camouflage system should preferably be securely but removably attached to the vehicle and cover as much as possible of the exterior surface of the vehicle without compromising vehicle features such as lights, muzzles, vehicle-mounted sensors, lookouts, stowage areas, refuelling capabilities, etc.

An example of a state-of-the-art mobile camouflage system is the MCS Mobile Camouflage System from SAAB Barracuda.

Mobile camouflage systems are generally not adaptable to different surrounding environments. Instead, a mobile camouflage system is normally configured and intended for use in one single type of landscape, such as a woodland landscape, a desert landscape or a winter landscape.

This is problematic since it makes the vehicle stand out from the surrounding environment as soon as it moves into a landscape for which the mobile camouflage system is not intended. For example, a mobile camouflage system for providing winter landscape camouflage typically offers poor protection within e.g. the visual wavelength regions when the winter landscape turns into a woodland landscape, and a mobile camouflage system for providing desert landscape camouflage typically offers poor protection in both visual and thermal wavelength regions when the desert landscape turns into a woodland landscape.

A quick-change visual deception system for visually disguising a physical item, such as a vehicle, is known from US2009/0252913A1. The system comprises multiple vinyl adhesive layers that are applied successively over a surface of the vehicle. Each of the vinyl adhesive layers has a different pattern from the layer preceding it. Each of the vinyl adhesive layers is configured to be easily removable from the preceding vinyl adhesive layer in order to reveal the underlying layer and its unique pattern upon removal of the uppermost layer. The system can be used as adaptive camouflage for military vehicles.

Although offering a visual camouflage that is adaptable to varying surrounding environments, the deception system in US2009/0252913A1 does not provide satisfactory adaption of the electromagnetic signature of the vehicle in wavelength regions outside the visible spectrum. Furthermore, the visual adaptability of the camouflage system is not a permanent feature of the camouflage system since a vinyl adhesive layer that has been removed cannot readily be reapplied to the vehicle.

There is thus a need for improvements within the field of mobile camouflage systems.

### SUMMARY OF THE INVENTION

It is an object of the present invention to provide a mobile camouflage system (MCS) that can be easily adapted to different surrounding environments.

In particular, it is an object of the invention to provide an MCS that allows the visual appearance of an object onto which the MCS is applied to be changed to better blend into the surrounding environment.

It is a further object of the invention to provide an MCS that allows the electromagnetic signature of the object, including wavelength regions outside the visible spectrum, to be changed to better blend into the surrounding environment.

This and other objects, which will become apparent in view of the description following hereinafter, are achieved according to a mobile camouflage system as defined by the appended claims.

According to one aspect of the present disclosure, there is provided an MCS for camouflaging vehicles, comprising a base camouflage material configured to be securely attached to a vehicle to be camouflaged, and at least one adaptive camouflage area having a camouflage pattern that can be adapted to a surrounding environment. The adaptive camouflage area comprises a patch arrangement comprising at least one patch that is movable between a first patch configuration in which the adaptive camouflage area exhibits a first camouflage pattern, and at least a second patch configuration in which the adaptive camouflage area exhibits a second camouflage pattern that is different than the first camouflage pattern.

By changing the camouflage pattern of the at least one adaptive camouflage area of the MCS, the overall camouflage pattern of the MCS is changed from a first overall camouflage pattern to a second overall camouflage pattern. The first camouflage pattern of the adaptive camouflage area may correspond to a base camouflage pattern of the MCS, for example a winter landscape camouflage pattern. The second camouflage pattern that is different than the first camouflage pattern, and thus different than the base camouflage pattern of the MCS, may, for example, correspond to a woodland camouflage pattern. In this way, a substantially coherent camouflage pattern of the MCS (e.g. a winter camouflage) can be easily changed into a blended camouflage pattern (e.g. a winter/woodland camouflage) in order for the vehicle to better blend into the surrounding environment.

In order to provide a significant change in the overall camouflage pattern of the MCS, the MCS preferably comprises a plurality of adaptive camouflage areas.

The at least one patch is configured to be repeatedly movable between the first patch configuration and the at least second patch configuration, which is advantageous in that it allows the camouflage pattern of the adaptive camouflage area to be changed in a reversible manner.

The adaptive camouflage area may comprise at least one concealable camouflage region, whereby the at least one patch may be configured to conceal the concealable camouflage region in the first patch configuration, and to expose the concealable camouflage region in the second patch configuration. By moving the patch between a first patch configuration, in which a concealable camouflage area is concealed by the patch, and a second patch configuration, in which the patch is moved into a position in which the concealable camouflaged area is revealed, an efficient way of exposing a previously concealed camouflage pattern of the MCS is provided.

The at least one patch may be configured to be attached to the base camouflage material of the mobile camouflage system in both the first and the second patch configurations. This facilitates handling of the MCS and prevents potential loss of patches. The patch may be at least releasably attached to the base camouflage material in both the first and the second patch configuration, meaning that the patch is either removably or permanently attached to the base camouflage material in the respective patch configuration.

In the second patch configuration in which the concealable camouflage region is exposed, the patch may be configured to be attached to the base camouflage material in a position adjacent to the concealable camouflage region, with a second side of the patch that is concealed in the first patch configuration now being exposed. This is advantageous in that not only one but two previously concealed surfaces, namely the surface of the concealable camouflage region and the surface of the second side of the patch, become exposed in the second patch configuration. This allows the overall camouflage pattern of the MCS to be varied to a greater extent. The two previously concealed surfaces may be provided with different camouflage patterns, allowing the overall camouflage pattern of the MCS to be efficiently blurred, or with corresponding camouflage patterns, allowing the overall camouflage patterns of the MCS to be more distinctly changed.

For example, the second side of the patch may be exposed by turning or reversing the patch in relation to the base camouflage material. This means that the patch has a first side that is exposed in the first patch configuration and a second side that is exposed in the second patch configuration. The first side of the patch may be provided with a first camouflage pattern and the second side may be provided with a second camouflage pattern that is different than the first camouflage pattern. The first camouflage pattern that is exposed in the first patch configuration may correspond to the base camouflage pattern of the MCS.

According to some aspects of the disclosure, the at least one patch of the patch arrangement is configured to be permanently attached to the base camouflage material. This is advantageous in that it facilitates movement of the patch between the first and the second patch configurations, and further prevents potential loss of patches.

For example, the at least one patch may be configured to be permanently attached to the base camouflage material along a first perimeter side of the patch, whereby the patch may be configured to be moved between the first and the second patch configurations by turning or folding the patch over the first perimeter side, much like turning a page in a book.

In some embodiments, the at least one patch has a regular shape, such as a rectangular shape, whereas at least the camouflage pattern of the second side of the patch, which side is concealed in the first patch configuration and exposed in the second patch configuration, is provided with an irregular camouflage pattern having a different shape than the patch. This is advantageous in that the regular shape of the patch facilitates movement of the patch between the first and second patch configurations, while the irregular shape of the camouflage pattern that is exposed by moving the patch into the second patch configuration efficiently blurs the overall camouflage pattern of the MCS. Furthermore, the regular shape of the at least one patch facilitates releasable attachment to the base camouflage material of perimeter sides of the patch that are not permanently attached to the base camouflage material, in both the first and the second patch configurations. It also facilitates manufacturing of the patch arrangement since both the patch and releasable attachment means for said releasable attachment become easier to manufacture and attach to the base camouflage material.

From the above it should be understood that the at least one patch may be configured to be releasably attached to the base camouflage material along at least a second perimeter side of the patch in both the first and the second patch configuration. Preferably, the patch is configured to be releasably attached to the base camouflage material along at least a second perimeter side that is remote from the first and permanently attached perimeter side. Most preferably, the patch is configured to be releasably attached to the base camouflage material along each perimeter side that is not permanently attached to the base camouflage material. This has the effect of securely attaching the patch to the base camouflage material in both the first and the second patch configuration while still allowing the patch to be easily moved between the two patch configurations.

The MCS may comprise releasable attachment means for the releasable attachment of the patch to the base camouflage material in any or both of the first and the second patch configurations. In order to prevent the releasable attachment means from undesirably affecting the electromagnetic signature of the MCS, the base camouflage material may comprise at least one flap that is configured to cover the releasable attachment means. An outer surface of the at least one flap may be provided with a camouflage pattern corresponding to the base camouflage pattern of the MCS.

The mobile camouflage system may be a panel based camouflage system comprising a plurality of panels together constituting the mobile camouflage system. This is advantageous in that it becomes easier to adapt the MCS to the features and the exterior surfaces of the vehicle to be camouflaged, and to securely attach the MCS to the vehicle.

One or more of the panels may comprise a patch arrangement as described above. Advantageously, the at least one patch of the patch arrangement is adapted in size and shape so as to make the at least one second perimeter side of the patch that is releasably attachable to the base camouflage material follow a perimeter side of the panel. This facilitates the releasable attachment of the patch to the base camouflage material and the manufacturing of the releasable attachment means, which releasable attachment means may be arranged along the perimeter side of the panel.

The base camouflage material of the MCS is the main component of the MCS and is preferably configured to cover substantially all passive and visible exterior surfaces of the vehicle. The concealable camouflage region that is covered by the patch in the first patch configuration is typically a region of the base camouflage material that is provided with a camouflage pattern that is different than the base camouflage pattern of the MCS. In some embodiments, all parts of the base camouflage material but the parts constituting concealable camouflage regions of adaptive camouflage areas are provided with the base camouflage pattern.

Once the base camouflage material has been applied to the vehicle, it is configured to remain stationary in relation to the vehicle. The base camouflage material is a passive component of the MCS in the meaning of not being moved when changing the camouflage pattern of the adaptive camouflage area. Only the patch is moved.

The MCS is configured to provide camouflage at least in the visual wavelength region of the electromagnetic spectrum. Preferably, however, the MCS is a multispectral camouflage system configured to provide camouflage in at least two and preferably all wavelength regions selected from the group consisting of the visual (VIS) wavelength region, the near infrared (NIR) wavelength region, the shortwave infrared (SWIR) wavelength region, the thermal infrared (TIR) wavelength region, and the radar wavelength region. When adapted for winter camouflage, the MCS is preferably also configured to provide camouflage in the ultraviolet (UV) wavelength region, and, in particular, the UV-A wavelength region of 350-400 nm.

Preferably, both the base camouflage material and the material of the movable patches are configured to provide multispectral camouflage within at least two and preferably all wavelength regions selected from the group consisting of the VIS, NIR, SWIR and TIR wavelength regions. In one exemplary embodiment, the base camouflage material is configured to provide camouflage at least within the VIS, NIR, SWIR, TIR and radar wavelength regions, whereas the patch material is configured to provide camouflage at least within the VIS, NIR, SWIR and TIR wavelength regions. The base camouflage material may be configured to underlie the patches of the MCS in all patch configurations. In this way, the MCS provides multispectral camouflage in all of the VIS, NIR, SWIR, TIR and radar wavelength regions, while allowing the camouflage within at least the VIS, NIR, SWIR and TIR regions to be adapted to the surrounding environment.

According to another aspect of the present disclosure, there is provided a vehicle, such as a military vehicle, comprising an MCS that is devised and configured as described above.

### BRIEF DESCRIPTION OF THE DRAWINGS

Further objects, features, and advantages of the present invention will appear from the following detailed description of some exemplary embodiments of the invention, of which some will be described in more detail with reference to the accompanying drawings, in which

FIG. 1 illustrates a panel based MCS according to an exemplary embodiment of the disclosure;

FIGS. 2A-2B illustrate the MCS when applied to a vehicle to be camouflaged;

FIGS. 3A-3C illustrate a patch arrangement of the MCS according to a first exemplary embodiment of the disclosure;

FIGS. 4A-4B illustrate a set of releasable attachment means for releasable attachment of a patch of the patch arrangement to a base camouflage material of the MCS, according to an exemplary embodiment of the disclosure;

FIGS. 5A-5C′ illustrate a patch arrangement of the MCS according to a second exemplary embodiment of the disclosure;

FIGS. 6A-6B′ illustrate a patch arrangement of the MCS according to a third exemplary embodiment of the disclosure;

FIGS. 7A-7B′ illustrate a patch arrangement of the MCS according to a fourth exemplary embodiment of the disclosure;

FIGS. 8A-8B illustrate a patch arrangement of the MCS according to a fifth exemplary embodiment of the disclosure;

FIG. 9 illustrates the structure of the base camouflage material of the MCS, according to an exemplary embodiment of the disclosure, and

FIGS. 10A-10B illustrate the structure of the patches of the MCS, according to an exemplary embodiment of the disclosure.

### DETAILED DESCRIPTION

The size, clear contours, hot surfaces and large radar cross sections make military vehicles highly exposed to visual detection and detection by various sensors and target acquisition systems. Vehicles therefore require advanced signature management equipment in order to achieve sufficient protection against detection, classification and identification. The present disclosure relates to a mobile camouflage system (MCS) that can be used for concealment of nearly any object but is particularly intended to provide protection for military vehicles during movement and in combat.

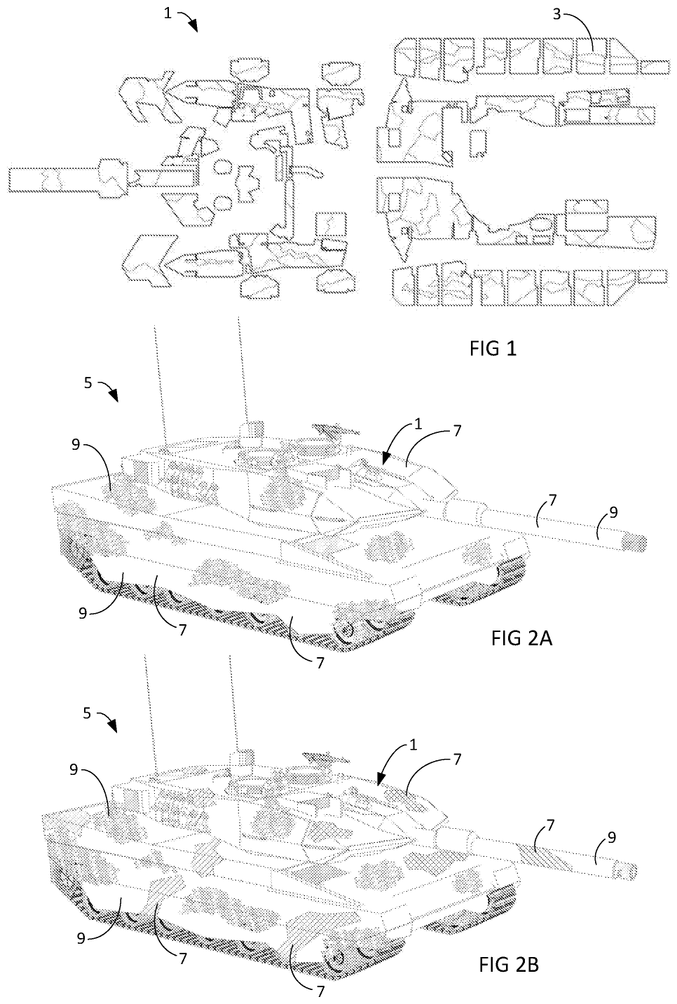

FIG. 1 illustrates an MCS 1 according to an exemplary embodiment of the present disclosure, prior to application of the MCS to a vehicle to be camouflaged.

In this embodiment, the MCS 1 is a modular or panel based camouflage system comprising a plurality of panels 3, together constituting the MCS. The MCS 1 is designed according to the requirements of the specific vehicle for which it is intended, in order to obtain optimal camouflage performance without affecting the functionality, handling or performance of the vehicle. Inversely, the design and attachment of the MCS 1 is adapted so as not to adversely affect the camouflage and camouflage performance during operation of the vehicle, e.g. during driving and firing.

The MCS 1 is particularly intended for military vehicles, such as armour-plated ground vehicles. In the exemplary embodiment illustrated in FIG. 1, the MCS 1 is configured for use with a main battle tank (MBT).

Although constituted by a plurality of individual camouflage panels 3 in the illustrated embodiment, it should be appreciated that the disclosure is not limited to a panel based MCS and that the MCS 1 could as well be manufactured as one substantially continuous camouflage construction that is applied to the vehicle in one or only a few separate pieces. However, the panel based design is advantageous in that it becomes easier to adapt the MCS 1 to the features and the exterior surfaces of the vehicle, and to securely attach the MCS to the vehicle.

The MCS 1 is configured to cover an area of the vehicle, which area is herein referred to as the camouflaged area of the vehicle. The camouflaged area of the vehicle substantially corresponds to the total visible exterior area of the vehicle, or at least substantially corresponds to the total passive, visible exterior area of the vehicle. The passive, visible exterior area of the vehicle is the exterior vehicle area that is visible during normal operation of the vehicle and which does not comprise features that cannot be covered by camouflage without jeopardizing vehicle operation or performance, such as wheels, tracks, lookouts, weapon muzzles, external sensors, etc.

The panels 3 are configured to be securely attached to the exterior surface of the vehicle. Preferably, the panels 3 are securely but removably attached to the vehicle to allow the MCS 1 to be subsequently dismounted from the vehicle, should that be desired. Each panel 3 may be individually attached to the vehicle whereafter adjacent panels may be attached to each other for a more robust camouflage construction.

The panels 3 are preferably attached to the vehicle by means of releasable attachment means, such as hook-and-loop fasteners (e.g., Velcro® fasteners), releasable adhesive, bayonet coupling mechanisms, magnets, or the like. Instead or in addition to such releasable attachment means, existing attachment means of the vehicle may be utilized to attach the panels 3 to the vehicle. For example, armour-plates are often bolted to the vehicle body of military vehicles. Such armour-bolts may protrude from the exterior surface of the vehicle and be used as releasable attachment means for the attachment of the MCS panels 3. Any of the above mentioned examples of releasable attachment means may also be used to attach the panels 3 to each other. In some embodiments, the panels 3 are attached to the vehicle and to each other by means of hook-and-loop fasteners, such as Velcro® fasteners. Releasable attachment means should herein be interpreted as a mechanism for attaching components to each other, which mechanism allows the components to be detached from each other without using tools. Furthermore, in contrast to permanent attachment means, releasable attachment means typically allow attached components to be detached from each other without causing substantial damage to any of the components.

The MCS 1 is configured to provide camouflage to the vehicle at least within the visible wavelength region. Preferably, the MCS 1 is configured to provide multispectral camouflage to the vehicle. Multispectral camouflage herein means camouflage within at least two wavelength regions selected from the group consisting of the visual (VIS) wavelength region, the near infrared (NIR) wavelength region, the shortwave infrared (SWIR) wavelength region, the thermal infrared (TIR) wavelength region and the radar wavelength region. That the MCS 1 is configured to provide camouflage means that the MCS 1 is configured to adapt the electromagnetic signature of the camouflaged vehicle in a way that makes the vehicle more difficult to detect visually and/or by means of electromagnetic sensors operative in the relevant wavelength region. Typically, it means that the MCS 1 is configured to adapt the electromagnetic signature of the vehicle to the electromagnetic signature of the surroundings in which the vehicle is intended to operate.

Preferably, the MCS 1 is configured to provide camouflage within at least two and preferably all wavelength regions within the electro-optical spectrum, including the VIS, NIR, SWIR and TIR wavelength regions. Preferably, the MCS 1 is also configured to provide camouflage within the radar wavelength region. That the MCS 1 is configured to provide camouflage within a named wavelength region means that the MCS is configured to provide camouflage within at least parts of the named wavelength region. As well known in the art, nomenclature and definitions of wavelength regions or sub-spectra of the electromagnetic spectrum may vary. For the purpose of this application, the following nomenclature and definitions will be used:

| Name of wavelength region | Wavelength region |
|---|---|
| VIS | 400 nm-750 nm |
| NIR | 750 nm-1500 nm |
| SWIR | 1500 nm-3 μm |
| TIR | 3 μm-12 μm |
| (MWIR) | (3 μm-5 μm) |
| (LWIR) | (8 μm-12 μm) |
| Radar | 1 mm-100 m |

MWIR (mid-wavelength infrared) and LWIR (long-wavelength infrared) are sub-bands within the TIR wavelength region.

As will be described in more detail below, the MCS 1 is typically adapted to prevent detection in VIS, NIR and SWIR by providing the MCS 1 with colour schemes, NIR and SWIR values and surface structures that causes the MCS 1 to visually blend into the surrounding environment. Additionally, the MCS 1 may comprise contour disrupters that may be applied to conspicuous parts of the vehicle to blur the contours of the vehicle.

The TIR properties of the MCS 1 may be adapted to obstruct thermal reconnaissance and reduce the risk of detection in all climate conditions. The thermal properties provide protection against thermal imagers and other related threats, such as heat seeking missiles.

The radar characteristics of the MCS 1 may be adapted to provide protection against radar reconnaissance and homing missiles in the frequency range of 1-100 GHz.

Besides providing protection in the VIS, NIR, SWIR, TIR and radar wavelength regions, the MCS 1 may be configured to provide protection also within the ultraviolet (UV) wavelength region, and in particular the UV-A wavelength region ranging between 350 and 400 nm. This is important for providing efficient winter camouflage.

FIGS. 2A and 2B illustrate the MCS 1 in FIG. 1 when attached to a vehicle 5.

The MCS 1 is an adaptive mobile camouflage system in the meaning of being adaptable to different surrounding environments. To this end, the MCS 1 comprises at least one and preferably a plurality (i.e. two or more) of areas 7 having a camouflage pattern that can be changed in order to adapt the overall camouflage pattern of the MCS to different surroundings. These areas of the MCS 1 are herein referred to as adaptive camouflage areas.

Areas 9 of the MCS 1 that are provided with a camouflage pattern that cannot be changed will hereinafter be referred to as static or non-adaptive camouflage areas. The non-adaptive camouflage areas 9 of the MCS 1 are typically but not necessarily provided with the same camouflage pattern. That different objects or areas are provided with the same or corresponding camouflage patterns herein means that they are provided with camouflage patterns adapted for the same type of surrounding environment, e.g. a woodland landscape, a winter landscape, a desert landscape, etc. The camouflage patterns of the non-adaptive camouflage areas 9 of the MCS 1 together form a static, non-adaptive camouflage pattern of the MCS 1, which non-adaptive camouflage pattern constitutes a base camouflage pattern (BCP) of the MCS. The BCP of the MCS 1 is typically selected in dependence of the intended operational area of the vehicle. Typically, all non-adaptive camouflage areas 9 of the MCS 1 are provided with the same camouflage pattern. For example, if the vehicle 5 is intended for operation in a winter landscape, all non-adaptive camouflage areas 9 of the MCS 1 may be provided with a winter camouflage pattern. The total area of the non-adaptive camouflage areas 9 is typically larger than the total area of the adaptive camouflage areas 7 and, therefore, the BCP is typically the most dominant camouflage pattern of the MCS 1. In the drawings, for illustrative purposes, only some of the adaptive 7 and non-adaptive 9 areas of the MCS 1 have been provided with reference signs.

Preferably, the MCS 1 comprises at least one adaptive camouflage area 7 that is located in the periphery of the MCS, i.e. an adaptive camouflage area having a perimeter side that coincides with a perimeter side or an outer boundary of the MCS, in order for the adaptive camouflage area to be able to effectively disrupt the contours of the electromagnetic signature of the MCS 1. For the same purpose, the MCS 1 preferably comprises at least one adaptive camouflage area 7 that stretches over an edge or a joint of the vehicle body. Preferably, the MCS 1 also comprises at least one non-peripheral adaptive camouflage area 7, i.e. an adaptive camouflage area that is completely surrounded by non-adaptive camouflage areas 9 of the MCS 1. Such a none peripheral adaptive camouflage area 7 has the effect of preventing large continuous areas of the MCS 1 from exhibiting the same electromagnetic signature.

Preferably, in order for the adaptive camouflage areas 7 of the MCS 1 to efficiently change the overall camouflage pattern of the MCS, at least 5%, more preferably at least 10%, and most preferably at least 15% of the total area of the MCS is constituted by adaptive camouflage areas 7. Preferably, the total area of the adaptive camouflage areas 7 constitutes at most 50%, more preferably at most 40%, and most preferably at most 30% of the total area of the MCS 1.

Typically, as mentioned above, the non-adaptive camouflage area 9 of the MCS 1 is substantially larger than the total area of the adaptive camouflage areas 7.

In FIG. 2A, the MCS 1 is configured to exhibit a first overall camouflage pattern OCP1, illustrated by white and dashed areas in the drawing. In FIG. 2B, the MCS 1 is configured to exhibit a second overall camouflage pattern OCP2, illustrated by white, dashed, and cross-ruled areas in the drawing. The change in overall camouflage pattern of the MCS 1 is achieved by changing the camouflage pattern of a plurality of adaptive camouflage areas 7 from a first camouflage pattern (illustrated in white in FIG. 2A) to a second and different camouflage pattern (illustrated by the cross-ruled pattern in FIG. 2B). How to change the camouflage pattern of the adaptive camouflage areas 7 in order to change the overall camouflage pattern of the MCS 1 from the first overall camouflage pattern OCP1 to the second overall camouflage pattern OCP2, or vice versa, will be described further below.

The first overall camouflage pattern OCP1 of the MCS 1 is adapted to provide camouflage in a first type of surroundings. For example, the first type of surroundings may be a winter landscape. In this case, white and dashed areas in the drawing represent areas of the MCS 1 provided with a winter camouflage pattern dominated by a white and/or grey colour scheme. For example, white areas of the drawing may represent white areas of the MCS 1, and dashed areas of the drawing may represent grey areas of the MCS. The first overall camouflage pattern OCP1 may correspond to the base camouflage pattern BCP of the MCS 1.

The second overall camouflage pattern OCP2 of the MCS 1 is adapted to provide camouflage in a second type of surroundings that are different than the first type of surroundings. For example, the second type of surroundings may be a mixture of a winter landscape and a woodland landscape (winter/woodland landscape). In this case, the cross-ruled pattern of the adaptive camouflage areas 7 in FIG. 2B may represent a woodland camouflage pattern dominated by a green and/or brown colour scheme. For example, cross-ruled areas may represent green areas of the MCS. Consequently, in this example, the at least one adaptive camouflage area 7 of the MCS 1 is configured to exhibit any of a winter camouflage pattern and a woodland camouflage pattern.

Typically, the at least one adaptive camouflage area 7 of the MCS 1 is configured to change the overall camouflage pattern of the MCS 1 from a coherent camouflage pattern, such as a woodland, winter, desert or mountain camouflage pattern, to a non-coherent or mixed camouflage pattern, such as a woodland/winter, winter/woodland, woodland/desert, desert/woodland, woodland/mountain, mountain/woodland, winter/mountain, mountain/winter, desert/mountain, mountain/desert camouflage pattern. To this end, each of the adaptive camouflage areas 7 are preferably configured to exhibit at least either of a first camouflage pattern corresponding to the base camouflage pattern, BCP, of MCS 1 and a second camouflage pattern that is distinctly different that the first camouflage pattern.

As well known in the art, there are numerous types of camouflage patterns adapted for different surroundings, including but not limited to camouflage patterns adapted for woodland, winter, desert, mountain, tropical, sub-tropical, maritime, and urban surroundings. It should be appreciated that the coherent camouflage pattern of the MCS 1 could be adapted to any of these surroundings, and that the non-coherent or mixed camouflage pattern could be adapted to any mixture thereof.

A camouflage pattern of an object should herein be interpreted as a property that affects the electromagnetic signature of the object. Different parts of the MCS 1 may have different camouflage patterns and the overall camouflage pattern of the MCS 1 is the electromagnetic signature of the MCS 1 provided by the combined effect of the camouflage patterns of all parts of the MCS. This means that changing a fraction of the camouflage pattern of the MCS 1 changes the overall camouflage pattern of the MCS 1, even if most of the camouflage pattern of the MCS 1 remains the same.

A camouflage pattern may affect the electromagnetic signature within one or several wavelength regions of the electromagnetic spectrum. Typically, the first overall camouflage pattern OCP1 and the second overall camouflage pattern OCP2 differ from each other at least in colour, meaning that a change from the first overall camouflage pattern to the second overall camouflage pattern changes the electromagnetic signature of the MCS 1 at least in the VIS wavelength region. Instead or in addition to colour, the first and the second overall camouflage patterns may differ from each in terms of thermal emissivity, and/or radar absorbing and/or reflecting capability. Thermal emissivity or emittance is a measure of the capability of the material of reflecting radiation in the TIR wavelength region. In snow and woodland landscapes, low-emissivity camouflage is desired in order to “cool” the TIR signature of the heat-generating vehicle by reflecting radiation from the relatively cold surroundings, and in particular from the cold sky. In desert landscapes, however, high-emissivity camouflage is desired in order not to cool the TIR signature of the vehicle below the high temperature of the sand in the surrounding environment. Therefore, in some embodiments, the MCS 1 may be advantageously configured to exhibit a first overall camouflage pattern and a second overall camouflage pattern that differ from each other in terms of any or both of colour and thermal emissivity.

According to the present disclosure, changing the overall camouflage pattern of the MCS 1 from the first overall camouflage pattern OCP1 to the second overall camouflage pattern OCP2, or vice versa, is effectuated by changing the camouflage pattern of the at least one adaptive camouflage area 7 of the MCS. Changing the camouflage pattern of an adaptive camouflage area 7 is in turn effectuated by means of a patch arrangement of the adaptive camouflage area 7, comprising at least one patch that is movable between a first patch configuration in which the adaptive camouflage area 7 exhibits a first camouflage pattern and at least a second patch configuration in which the adaptive camouflage area 7 exhibits a second camouflage pattern that is different than the first camouflage pattern. The at least one patch is repeatedly movable between the first and the at least second patch configuration to allow the camouflage pattern of the adaptive camouflage area 7 to be repeatedly changed between the first and the second camouflage pattern, thereby allowing the overall camouflage pattern of the MCS 1 to be changed back and forth between the first OCP1 and the second OCP2 overall camouflage pattern. The patch arrangement is thus configured to change the camouflage pattern of the adaptive camouflage area in a reversible manner.

That the patch is movable means that it is movably arranged in relation to a base camouflage material of the MCS 1, which base camouflage material constitutes the main component of the MCS 1, as will be further described below.

The patch typically has a first side that is provided with a first camouflage pattern. The first side of the patch, and thus the first camouflage pattern, is exposed when the patch is arranged in the first patch configuration. The patch arrangement further comprises at least one concealable camouflage region that is provided with a second camouflage pattern that is different than the first camouflage pattern of the first side of the patch. The concealable camouflage region is concealed (i.e. unexposed) when the patch is arranged in the first patch configuration. When the patch is moved into the second patch configuration, the concealable camouflage region and the second camouflage pattern becomes exposed, thereby changing the camouflage pattern of the adaptive camouflage area 7, as well as the overall camouflage pattern of the MCS 1. The concealable camouflage region may be located in an area of the base camouflage material that is covered by the patch when the patch is arranged in the first patch configuration and uncovered by the patch when the patch is arranged in the second patch configuration.

Exposure of a previously unexposed or concealed camouflage pattern has the effect of changing the electromagnetic signature of the MCS 1. Typically but not necessarily, exposure of a camouflage pattern herein means that it is visually exposed to an observer located outside of the vehicle.

Furthermore, a second side of the patch that is unexposed when the patch is arranged in the first patch configuration may be provided with a third camouflage pattern. In some patch configurations, which will be further described below, the second side of the patch, and thereby the third camouflage pattern, may be exposed adjacent to the second camouflage pattern of the concealable camouflage region. In other patch configurations, the patch may be applied over the concealable camouflage region with the second side of the patch facing outwards, thereby concealing the second camouflage pattern while exposing the third camouflage pattern.

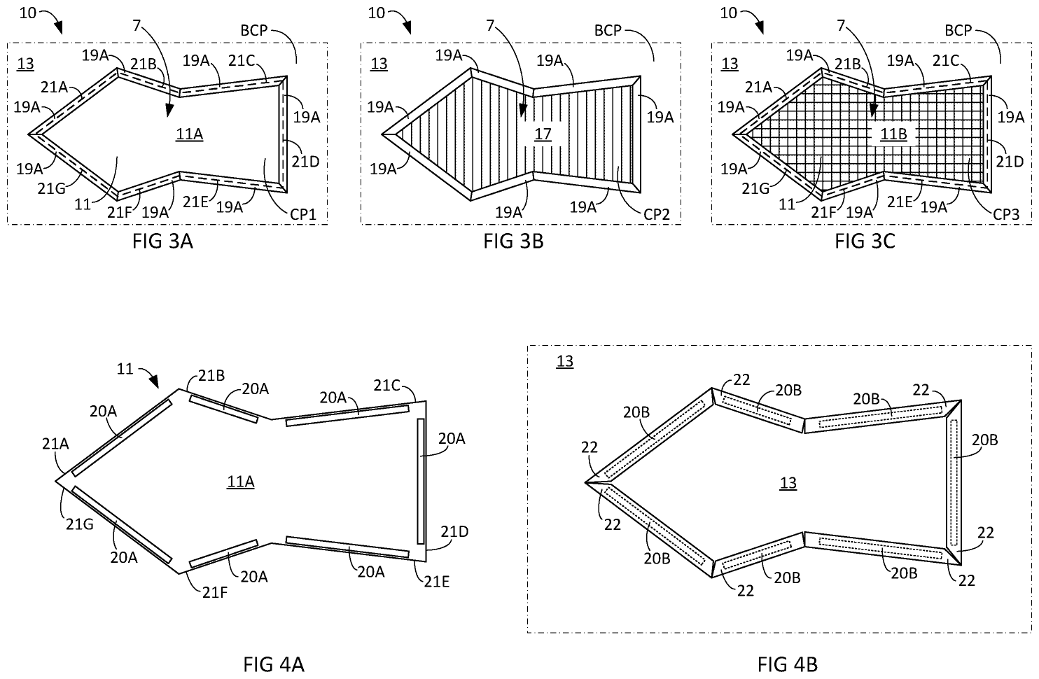

FIGS. 3A-3C illustrate a first exemplary embodiment of a patch arrangement 10 according to the present disclosure. Each adaptive camouflage area 7 of the MCS 1 comprises a patch arrangement 10 allowing the camouflage pattern of the adaptive camouflage area 7 to be changed. The patch arrangement 10 comprises a patch 11 for effectuating the change in camouflage pattern of the adaptive camouflage area 7. In this embodiment, the patch 11 is configured to be removed from the MCS 1 in order to reveal a concealable camouflage region 17 that is covered by the patch 11 in the first patch configuration.

When the patch 11 is arranged in the first patch configuration, illustrated in FIG. 3A, the patch overlies the concealable camouflage region 17. In this configuration, the patch 11 covers and conceals the concealable camouflage region 17 to prevent it from being exposed to any observer. A first side 11A of the patch 11, which first side 11A faces away from the vehicle 5 in the first patch configuration, is provided with a first camouflage pattern CP1. That the first side 11A of the patch 11 is provided with a first camouflage pattern means that the patch 11 exhibits the first camouflage pattern when the first side 11A of the patch faces an observer. The concealable camouflage region 17 is provided with a second camouflage pattern CP2 that is different than the first camouflage pattern CP1. In the first patch configuration, the exposure of the first side 11A of the patch 11 causes the adaptive camouflage area 7 to exhibit the first camouflage pattern CP1 and so causes the MCS 1 to exhibit the first overall camouflage pattern OCP1. The first camouflage pattern CP1 of the first side 11A of the patch 11 may correspond to a base camouflage pattern BCP of the MCS 1.

In the second patch configuration, illustrated in FIG. 3B, the patch 11 is removed from the base camouflage material 13 to reveal the second camouflage pattern CP2 of the concealable camouflage region 17, causing the MCS 1 to exhibit the second overall camouflage pattern OCP2. The concealable camouflage region 17 is typically a region of the base camouflage material 13 underlying the patch 11 in the first patch configuration, which region has been provided with a distinct camouflage pattern CP2 that differs from the base camouflage pattern BCP of the MCS 1.

In order for the patch 11 to be removable from the MCS 1 while yet securely attached to the MCS 1 when in the first patch configuration, the patch 11 may be releasably attached to the base camouflage material 13 by means of a first set of releasable attachment means 19A.

The first set of releasable attachment means 19A are configured to releasably attach the patch 11 to the base camouflage material 13. The number of releasable attachment means required in order to securely attach the patch 11 to the base camouflage material 13 depend on the size and shape of the patch 11. At a minimum, the first set of releasable attachment means 19A is configured to releasably attach at least two remote parts of the patch 11 to the base camouflage material 13. Preferably, the first set of releasable attachment means 19A is configured to releasably attach at least half of a plurality of perimeter sides 21A-G of the patch 11 to the base camouflage material 13. Even more preferably, the first set of releasable attachment means 19A is configured to releasably attach each of the perimeter sides 21A-G of the patch 11 to the base camouflage material 13. Most preferably, the first set of releasable attachment means 19A is configured to releasably attach each of the perimeter sides 21A-G of the patch 11 along substantially the entire length of each perimeter side 21A-G.

FIGS. 4A-4B illustrates a more detailed view of the releasable attachment means 19A illustrated in FIGS. 3A-3C. The first set of releasable attachment means 19A may comprise a set of hook-and-loop fasteners, such as Velcro® fasteners. As illustrated in FIG. 4A, engaging members 20A (e.g. tapes with Velcro® hooks) may be applied along each perimeter side 21A-21G of the patch 11. The engaging members may be applied along each perimeter side 21A-21G on both sides of the patch 11 to allow the patch 11 to be releasably attached to the base camouflage material 13 with any of the first side 11A of the patch or a second side of the patch facing outwards. As illustrated in FIG. 4B, matching engaging members 20B (e.g. tapes with Velcro® loops) configured to releasably engage with the engaging members 20A of the patch 11 may be correspondingly arranged on the base camouflage material 13. The matching engaging members 20B of the base camouflage material 13 may be arranged on flaps 22 that are permanently attached to the base camouflage material 13, for example through stitching. When the patch 11 is releasably attached to the base camouflage material 13, the flaps 22 may be configured to overlie and cover the perimeter sides 21A-G of the patch 11 with an outward-facing side of each flap 22 facing away from the vehicle and an inward-facing side of each flap facing inward, towards the patch 11. The outward-facing sides of the flaps 22 may be provided with a camouflage pattern, preferably a camouflage pattern corresponding to the base camouflage pattern BCP of the MCS 1, while the inward-facing sides of the flaps 22 are provided with the matching engaging members 20B for engagement with the engaging members 20A arranged along the perimeter sides 21A-21G of the patch 11. In this way, the releasable attachment means 19A become hidden by camouflaged flaps 22 so as not to undesirably affect the electromagnetic signature of the MCS 1. Furthermore, the flaps 22 prevent branches, twigs or other objects from tearing off the patch 11 from the MCS 1 during operation of the vehicle 5.

Returning now to FIGS. 3A-3C, once the patch 11 has been removed from the base camouflage material 13 it can at any time be reattached by means of the first set of releasable attachment means 19A. If the patch 11 is reattached with its first side 11A facing outward (i.e. away from the vehicle), the first patch configuration illustrated in FIG. 3A is restored, causing the overall camouflage pattern of the MCS 1 to be switched back to the first overall camouflage pattern OCP1.

The second side 11B of the patch 11 (i.e. the side opposite to the first side 11A) may be provided with a third camouflage pattern CP3 that differs from both the first camouflage pattern CP1 of the first side 11A of the patch 11 and the second camouflage pattern CP2 of the concealable camouflage region 17. By reattaching the patch 11 with the second side 11B facing outwards, a third patch configuration in which the third camouflage pattern CP3 is exposed is achieved, as illustrated in FIG. 3C. Exposure of the third camouflage pattern CP3 changes the overall camouflage pattern of the MCS 1 into a third overall camouflage pattern that is different than both the first overall camouflage pattern OCP1 and the second overall camouflage pattern OCP2.

In order for the patch 11 to be attached to the base camouflage material by means of the engaging members 20A and 20B with any of the first 11A or the second side 11B of the patch facing outwards, the patch should preferably have a symmetrical shape, meaning that it should be mirror-symmetric about at least one centre axis of the patch. In the illustrated example, the patch 11 is mirror-symmetric about a horizontal centre axis of the patch 11. Nevertheless, it should be understood that also asymmetric patches could be used in order to change the camouflage pattern of an adaptive camouflage area 7 between at least two different camouflage patterns.

Consequently, the MCS 1 comprises at least one adaptive camouflage area 7 constituting a sub-area of the camouflaged area, which adaptive camouflage area has a first camouflage pattern that can be changed into at least a second camouflage pattern in order to adapt the overall camouflage pattern of the MCS 1 to the surrounding environment. For example, if the base camouflage pattern BCP of the base camouflage material 13 is a woodland camouflage pattern dominated by a green and/or brown colour scheme, the first camouflage pattern CP1 of the first side 11A of the patch 11 may also be a woodland camouflage pattern that is also dominated by a green and/or brown colour scheme, the second camouflage pattern CP2 of the concealable camouflage region 17 may be a winter camouflage pattern dominated by a white and/or grey colour scheme, and the third camouflage pattern CP3 of the second side 11B of the patch 11 may be a desert camouflage pattern dominated by a brown and/or yellow colour scheme. In this scenario, the camouflage pattern of the adaptive camouflage area 7 could thus be adapted to make the overall camouflage pattern of the MCS 1 correspond to any of a woodland camouflage pattern, a woodland/winter camouflage pattern, or a woodland/desert camouflage pattern. According to another exemplary embodiment, the base camouflage pattern BCP of the base camouflage material 13 and the first camouflage pattern CP1 of the first side 11A of the patch 11 may be a desert camouflage pattern dominated by a brown and/or yellow colour scheme, whereas the second camouflage pattern CP2 of the concealable camouflage region 17 may be a woodland camouflage pattern dominated by a green and/or brown colour scheme, and the third camouflage pattern CP3 of the second side 11B of the patch 11 may be a mountain camouflage pattern dominated by a black and/or grey colour scheme. In this scenario, the camouflage pattern of the adaptive camouflage area 7 could thus be adapted to make the overall camouflage pattern of the MCS 1 correspond to any of a desert camouflage pattern, a desert/woodland camouflage pattern, or a desert/mountain camouflage pattern.

Of course, as understood by the skilled reader, the camouflage patterns of the concealable camouflage region 17, the first side 11A of the patch 11, and the second side 11B of the patch 11 could be re-casted as desired. For example, the second camouflage pattern CP2 of the concealable camouflage region 17 may correspond to the base camouflage pattern BCP of the MCS 1, whereas the first 11A and the second 11B sides of the patch 11 may be provided with mutually different camouflage patterns that differ also from the second camouflage pattern CP2 of the concealable camouflage region 17. For example, if the vehicle 5 is mainly intended for operation in woodland landscapes and the base camouflage pattern BCP of the MCS 1 is a woodland camouflage pattern, it may be desirable to provide also the concealable camouflage region 17 of the adaptive camouflage area 7 with a woodland camouflage pattern so as not to require the patch 11 to be attached to the MCS 1 during normal operation of the vehicle. In this case, the first side 11A of the patch 11 may be provided with e.g. a winter camouflage pattern whereas the second side 11B of the patch 11 may be provided with e.g. a mountain camouflage pattern. If moving into snowy and/or rocky geographical areas, some or all of the adaptive camouflage areas 7 of the MCS 1 may then be provided with any of a winter or mountain camouflage pattern by covering some or all of a plurality of concealable camouflage regions 17 with patches 11 having either their first or their second side facing outwards.

In the embodiments described above, the patches 11 of the patch arrangements 10 are intended to be stowed away and stored when not in use. This may cause patches to be lost and thus jeopardize the adaptive camouflage capabilities of the MCS1.

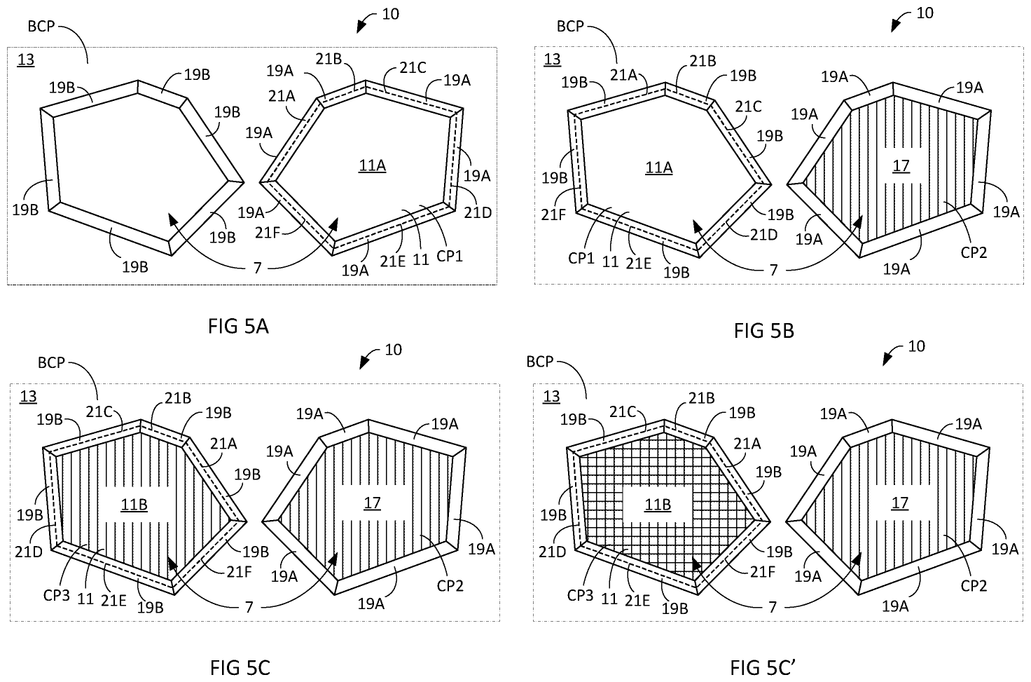

FIGS. 5A-5C′ illustrate another exemplary embodiment of a patch arrangement 10 in which the patch 11 is configured to be attached to the base camouflage material 13 of the MCS 1 in both the first and the second patch configuration, and preferably in all patch configurations. In this embodiment, the patch arrangement 10 comprises, besides the first set of releasable attachment means 19A, a second set of releasable attachment means 19B for releasably securing the patch 11 to the base camouflage material 13 in the second patch configuration in which the concealable camouflage region 17 is revealed. Consequently, in the first patch configuration, the first set of releasable attachment means 19A is configured to releasably attach the patch 11 to the base camouflage material 13 at a first position in which it covers and conceals the concealable camouflage region 17, whereas, in the second patch configuration, the second set of releasably attachment means 19B is configured to releasably attach the patch 11 to the base camouflage material 13 at a second position in which the concealable camouflage region 17 is revealed. Like in FIGS. 3A-3C, the first side 11A of the patch 11, which first side faces outwards when the patch is arranged in the first patch configuration, is provided with a first camouflage pattern CP1, and the concealable camouflage region 17 is provided with a second camouflage pattern CP2 that differs from the first camouflage pattern.

Besides having the advantage of securely attaching the patch 11 to MCS 1 in the second patch configuration, the second set of releasable attachment means 19B provides the effect of allowing the overall camouflage pattern of the MCS 1 to be varied to a greater extent. This is because the adaptive camouflage area 7 may be made twice the size of the patch 11. Furthermore, the adaptive camouflage area 7 becomes divided into two sub-areas that are capable of simultaneously exhibiting either the same or different camouflage patterns.

The second set of releasable attachment means 19B is preferably devised and configured in accordance with the first set of releasable attachment means 19A, as described above with reference to FIGS. 3A-3C and FIGS. 4A-4B.

FIG. 5A illustrates the patch 11 when arranged in the first patch configuration in which the patch 11 conceals the concealable camouflage region 17 with the first side 11A of the patch 11 being exposed. The first camouflage pattern CP1 of the first side 11A of the patch 11 corresponds to the base camouflage pattern BCP of the MCS 1.

FIGS. 5B and 5C illustrate the patch 11 when arranged in other patch configurations in which the patch reveals the concealable camouflage area 17. In these patch configurations the patch 11 is securely attached to the base camouflage material 13 at the second position by means of the second set of releasable attachment means 19B. The patch 11 can be attached in the second position in any of a second patch configuration, illustrated in FIG. 5B, or a third patch configuration illustrated in FIG. 5C.

In the second patch configuration, illustrated in FIG. 5B, the patch 11 is attached in the second position with the first side 11A of the patch 11, having a camouflage pattern CP1 corresponding to the base camouflage pattern BCP of the MCS 1, still facing outwards. This has the effect of changing the camouflage pattern of only a part of the adaptive camouflage area 7, which may be advantageous when only a small adjustment of the first overall camouflage pattern OCP1 of the MCS 1 is desired.

In the third patch configuration, illustrated in FIG. 5C, the patch 11 is attached in the second position with the second side 11B of the patch facing outwards. In this example, the second side 11B is provided with a third camouflage pattern CP3 that corresponds to the second camouflage pattern CP2 of the concealable camouflage region 17. This has the effect of changing the camouflage pattern of the entire adaptive camouflage area 7 into a coherent camouflage pattern provided on both the second side 11B of the patch 11 and the concealable camouflage region 17. In this way, the camouflage pattern of an adaptive camouflage area 7 having an area that is twice the area of the movable patch 11 can be changed simply by moving the patch from one patch configuration to another. For practical reasons, the area of the movable patch 11 should not be too big, since that would render efficient movement and handling of the patch difficult. At the same time, the adaptive camouflage area 7 should be big enough to change the overall camouflage pattern of the MCS 1 as perceived by a remote observer either visually or via available sensors. Therefore, it is advantageous to have the same or substantially the same camouflage pattern on both the second side 11B of the patch 11 and the concealable camouflage area 17, and, when the overall camouflage pattern of the MCS 1 is to be changed, to move the patch 11 to a position adjacent to the concealable camouflage area 17 with the second side 11B of the patch facing outwards.

Consequently, it is preferred that the first and second sets of releasable attachment means 19A, 19B are configured to releasably attach the patch 11 to the base camouflage material 13 in first and second positions that are in close proximity to each other. This is advantageous both in that it facilitates movement of the patch 11 and in that the corresponding camouflage patterns of the second side 11B of the patch 11 and the concealable camouflage region 17 will be perceived as a continuous area having the same or substantially the same electromagnetic signature, at least from a typical threat distance.

FIG. 5C′ illustrates the effect provided if the second side 11B of the patch 11 in FIGS. 5A-5C would be provided with a camouflage pattern CP3 that is different than both the base camouflage pattern BCP of the MCS 1 and the second camouflage pattern CP2 of the concealable camouflage region 17. When, in this scenario, the patch 11 is attached in the second position with the second side 11B of the patch facing outwards, the camouflage pattern of the adaptive camouflage area 7 is changed from the base camouflage pattern BCP into two other and mutually different camouflage patterns CP2, CP3. This may be advantageous in certain terrains or situations in order to more efficiently blend into the surrounding environment or to further blur a high-resolution image of the electromagnetic signature of the MCS 1. In accordance with the exemplary embodiment illustrated in FIGS. 3A-3C, the patch 11 should preferably be symmetrically shaped in order for the patch to be moved into the second position with any of its first 11A or second side 11B facing outwards.

Instead of being fully releasable from the base camouflage material 13 and re-attachable thereto in another position in which the patch 11 reveals the concealable camouflage region 17, as illustrated in FIGS. 5A-5C′, the patch 11 may be permanently attached to the base camouflage material 13 along at least one perimeter side of the patch 11, as will be described below with reference to some exemplary embodiments. This has the effect of preventing patches 11 from being lost during operation of the vehicle or during handling or storage of the patches. It also has the effect of facilitating the movement of patches 11 required to change the camouflage pattern of the adaptive camouflage areas 7.

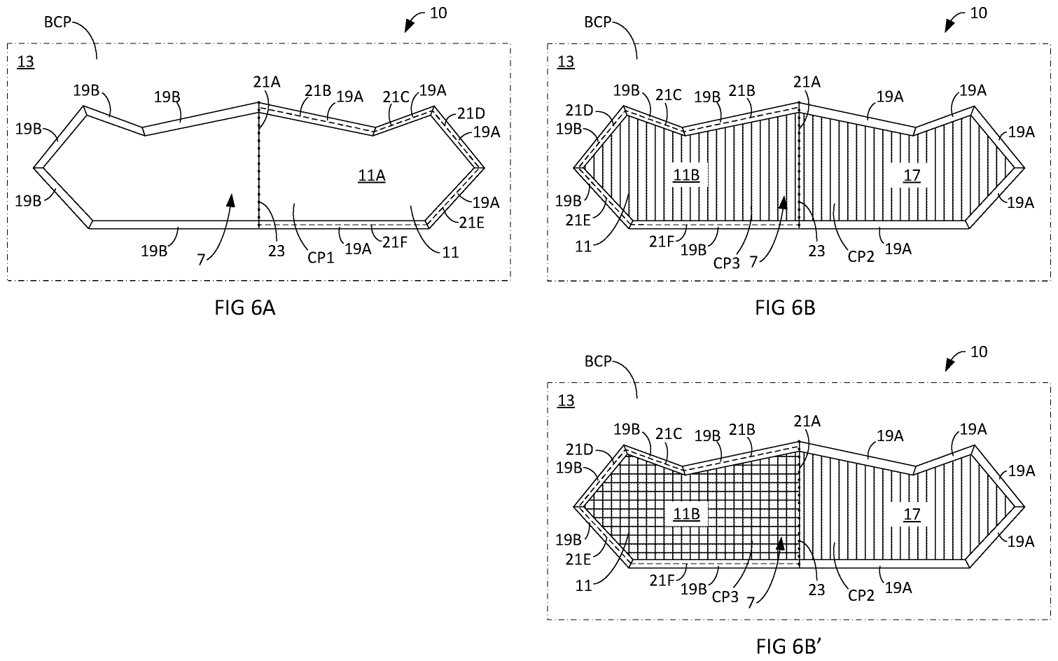

FIGS. 6A-6B′ illustrate an exemplary embodiment of a patch arrangement in which the patch 11 is permanently attached to the base camouflage material 13.

The patch 11 is permanently attached to the base camouflage material 13 at or close to a perimeter side 21A of the patch. The patch 11 may be permanently attached to the base camouflage material 13 at a single point of attachment, allowing the patch 11 to be rotated between the various patch configurations in a main plain of extension of the patch. Preferably, however, the patch 11 is configured to be moved between the different patch configurations by turning or folding the patch over the perimeter side 21A that is permanently attached to the base camouflage material 13. To facilitate folding, the patch 11 is preferably permanently attached to the base camouflage material 13 along substantially the entire length of the perimeter side 21A.

The patch 11 is permanently attached to the base camouflage material 13 by means of permanent attachment means 23. Non-limiting examples of suitable permanent attachment means are stitches and permanent (non-releasable) adhesive. In the illustrated embodiment, the permanent attachment means 23 comprises stitches, and the patch 11 is stitched to the base camouflage material 13 along substantially the entire length of a perimeter side 21A of the patch. Permanent attachment means should herein be interpreted as a mechanism for attaching components to each other, which mechanism does not allow the components to be detached from each other without using tools. Furthermore, in contrast to releasable attachment means, permanent attachment means typically do not allow attached components to be detached from each other without causing substantial damage to any of the components.

In addition to the permanent attachment means 23, the patch arrangement still comprises a first set of releasable attachment means 19A to securely maintain the patch 11 in a first patch configuration, and a second set of releasable attachment means 19B to securely maintain the patch in the second patch configuration. The first and second sets of releasable attachment means 19A, 19B are configured to releasably attach parts of the patch 11 that are not permanently attached to the base camouflage material 13 via the permanent attachment means 23 to the base camouflage material 13. The first and second sets of releasable attachment means 19A, 19B are configured to releasably attach, to the base camouflage material 13, at least a part of the patch 11 that is remote to the part of the patch 11 that is permanently attached to the base camouflage material. Preferably, the first and second sets of releasable attachment means 19A, 19B are configured to releasably attach each of a plurality of non-permanently attached perimeter sides 21B-F of the patch 11 to the base camouflage material 13. Even more preferably, the first and second sets of releasable attachment means 19A, 19B are configured to releasably attach each of the non-permanently attached perimeter sides 21B-F to the base camouflage material 13 along substantially the entire length of each perimeter side 21B-F. To this end, the first and second sets of releasable attachment means 19A, 19B may be devised and configured as described above with reference to FIGS. 4A-4B.

FIG. 6A illustrates the patch 11 when arranged in the first patch configuration in which the patch 11 conceals the concealable camouflage area 17 with the first side 11A of the patch 11 being exposed. The first camouflage pattern CP1 of the first side 11A of the patch 11 may correspond to the base camouflage pattern BCP of the base camouflage material 13.

FIGS. 6B and 6B′ illustrate the patch 11 when arranged in a second patch configuration in which the patch reveals the concealable camouflage region 17 and causes the second camouflage pattern CP2 of the concealable camouflage region 17 to be exposed. The patch 11 is moved into the second patch configuration by releasing the patch 11 from the first set of releasable attachment means 19A, folding the patch 11 over the perimeter side 21A of the patch that is permanently attached to the base camouflage material 13, and releasably attaching the patch to the base camouflage material 13 in the second patch configuration using the second set of releasable attachment means 19B.

In the example illustrated in FIG. 6B, the concealable camouflage region 17 is provided with a second camouflage pattern CP2 that differs from the base camouflage pattern BCP of the base camouflage material 13, and the second side 11B of the patch 11 is provided with a camouflage pattern CP3 corresponding to that of the concealable camouflage region 17. This has the effect of creating a large area having a coherent camouflage pattern that differs from the base camouflage pattern BCP, which is advantageous for reasons mentioned above with reference to FIG. 5C.

In the example illustrated in FIG. 6B′, the second side 11B of the patch 11 is provided with a camouflage pattern CP3 that is different than both the base camouflage pattern BCP and the second camouflage pattern CP2 of the concealable camouflage region 17. This has the effect of changing the camouflage pattern of the adaptive camouflage area 7 into two other and mutually different camouflage patterns CP2, CP3, which may be advantageous for reasons mentioned above with reference to FIG. 5C′.

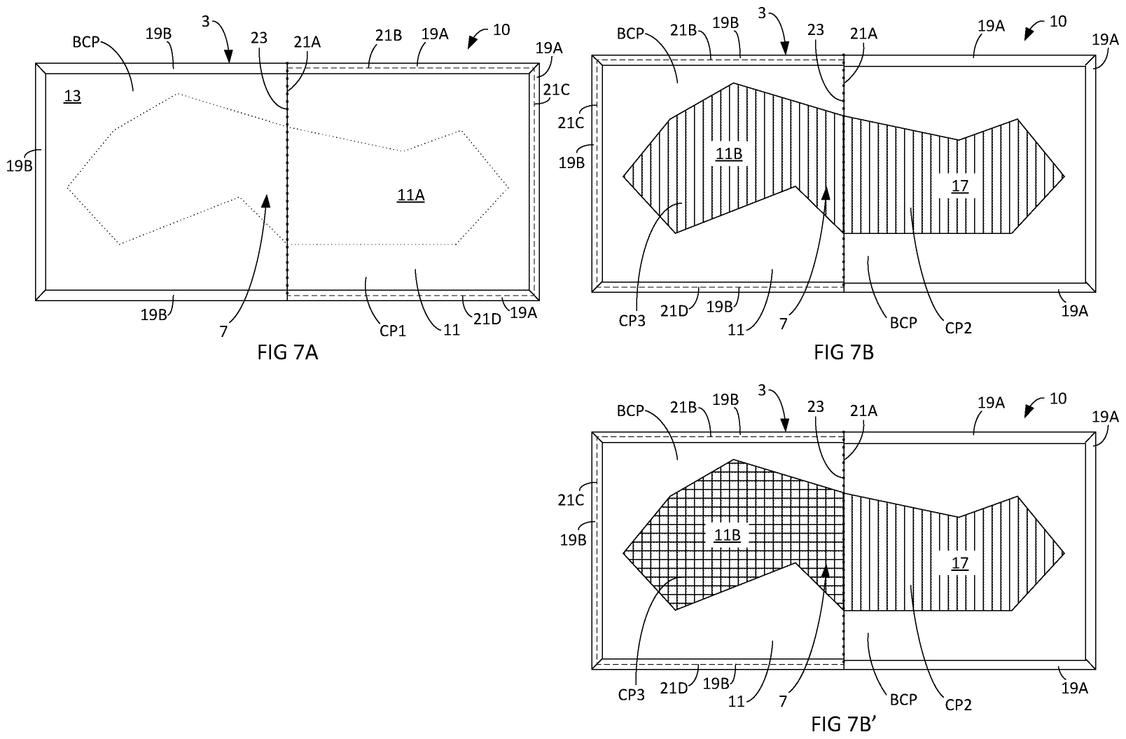

FIGS. 7A-7B′ illustrate another exemplary embodiment of a patch arrangement in which the patch 11 is permanently attached to the base camouflage material 13.

In this embodiment, the patch 11 has a regular shape to facilitate folding or turning of the patch over the perimeter side 21A, and to facilitate releasable attachment of parts of the patch 11 to the base camouflage material 13 using any of the first 19A and the second 19B sets of releasable attachment means. Preferably but not necessarily, the patch 11 has a substantially rectangular shape.

Another advantage of using patches 11 having a regular shape is that they are relatively easy to manufacture. In particular when the MCS 1 is a panel-based MCS, as illustrated in FIG. 1, rectangular patches 11 are relatively easy to manufacture. This is because at least some of the panels 3 that are put together to form the MCS 1 normally have a rectangular shape and a size that makes them suitable for comprising patch arrangements like the one illustrated in FIGS. 7A-7B′. It should thus be realised that the rectangular piece of base camouflage material 13 to which the patch 11 is permanently attached, illustrated in FIGS. 7A-7B′, may constitute a rectangular panel 3 of a panel based MCS 1.

As illustrated in the drawings, the patch 11 may have an area that substantially corresponds in shape and size to half the area of the panel 3 onto which it is attached. The patch 11 is permanently attached, e.g. through stitching, to the panel 3 along a perimeter side 21A of the patch 11 that runs substantially along a centre line of the panel 3. The perimeter sides 21B-21D of the patch 11 that are not permanently attached to the panel 3 substantially follow the perimeter sides of the panel 3 both in the first patch configuration, illustrated in FIG. 7A, and in the second patch configuration, illustrated in FIGS. 7B and 7B′. This is advantageous in that the first and second sets of releasable attachment means 19A, 19B for releasably attaching parts of the patch 11 to the panel 3 in the first and second patch configuration, respectively, can be arranged along the perimeter sides of the panel, which facilitates manufacturing of the panel 3. Furthermore, the rectangular shape of the patch 11 typically reduces the number of releasable attachment means 19A, 19B required to securely maintain the patch 11 in the different patch configurations, as compared to the number of attachment means required for a more irregularly shaped patch. In all other aspects, the first and second sets of releasable attachment means 19A, 19B may be devised and configured as described with reference to FIGS. 6A-6B′.

FIG. 7A, illustrates the patch 11 when arranged in the first patch configuration in which the patch 11 conceals the concealable camouflage area 17 with the first side 11A of the patch 11 being exposed. The first camouflage pattern CP1 of the first side 11A of the patch 11 corresponds to the base camouflage pattern BCP of the MCS 1. Consequently, in the first patch configuration, the camouflage pattern of the adaptive camouflage area 7 corresponds to the base camouflage pattern BCP of the MCS 1. It should be noted that the dashed adaptive camouflage area 7 is not visible in the first patch configuration illustrated in FIG. 7A. It is indicated only to illustrate the area of the MCS that can be provided with different camouflage patterns by means of the patch arrangement 10, and so constitutes an adaptive camouflage area 7 in the meaning of this disclosure.

FIGS. 7B and 7B′ illustrate the patch 11 when arranged in a second patch configuration in which the patch reveals the concealable camouflage region 17 and causes the second camouflage pattern CP2 of the concealable camouflage region 17 to be exposed. The patch 11 is moved into the second patch configuration by releasing the patch 11 from the first set of releasable attachment means 19A, folding the patch 11 over the perimeter side 21A of the patch that is permanently attached to the base camouflage material 13, and releasably attaching the patch to the base camouflage material 13 in the second patch configuration using the second set of releasable attachment means 19B.

In the example illustrated in FIG. 7B, the concealable camouflage region 17 is provided with a second camouflage pattern CP2 that differs from the base camouflage pattern BCP of the MCS 1, and the second side 11B of the patch 11 is provided with a third camouflage pattern CP3 corresponding to that of the concealable camouflage region 17. This has the effect of creating a large area having a coherent camouflage pattern that differs from the base camouflage pattern BCP, which is advantageous for reasons mentioned above with reference to FIG. 5C.

In the example illustrated in FIG. 7B′, the second side 11B of the patch 11 is provided with a camouflage pattern CP3 that is different than both the base camouflage pattern BCP of the MCS 1 and the second camouflage pattern CP2 of the concealable camouflage region 17. This has the effect of changing the camouflage pattern of the adaptive camouflage area 7 into two other and mutually different camouflage patterns CP2, CP3, which may be advantageous for reasons mentioned above with reference to FIG. 5C′.

Preferably, at least in the VIS wavelength region, the second camouflage pattern CP2 of the concealable camouflage region 17 and the third camouflage pattern CP3 of the second side 11B of the patch 11 should have irregular shapes so as to minimize the risk of detection. Therefore, the concealable camouflage region 17 may advantageously be provided with a second camouflage pattern CP2 that is irregularly shaped and covers only parts of the concealable camouflage region 17. The remains of the concealable camouflage region 17, i.e. parts of the concealable camouflage region 17 that are not provided with the second camouflage pattern CP2, may advantageously be provided with a camouflage pattern corresponding to the base camouflage pattern BCP. Likewise, the second side 11B of the patch 11 may advantageously be provided with a third camouflage pattern CP3 that is irregularly shaped and covers only parts of the second side 11B of the patch 11. The remains of the second side 11B of the patch 11, i.e. parts of the second side 11B of the patch 11 that are not provided with the third camouflage pattern CP3, may advantageously be provided with a camouflage pattern corresponding to the base camouflage pattern BCP. As described above, the second camouflage pattern CP2 and the third camouflage pattern CP3 typically differ from the base camouflage pattern BCP, and may or may not be mutually different.

An advantage of providing only parts of the concealable camouflage region 17 and the second side 11B of the patch with the second CP2 and third CP3 camouflage patterns, respectively, is that the camouflage patterns do not have to be mirror-symmetric, which is the case if the entire concealable camouflage region 17 and the entire second side 11B of the patch 11 would be provided with the respective camouflage pattern, as best understood by studying FIGS. 6A-6B′. Consequently, this feature allows irregular and optimally adapted camouflage patterns CP2, CP3 to be used while facilitating manufacturing and handling of the patches 11.

Notably, the embodiments illustrated in FIGS. 6A-6B′ and 7A-7B′ allow the camouflage pattern of the adaptive camouflage area 7 to be changed by folding or turning the patch 11 over a perimeter side 21A of the patch that is permanently attached to the base camouflage material 13, much like turning the page in a book. Indeed, these patch arrangements may very well comprise two or more patches that are movably arranged between the first and the second patch configuration in a way corresponding to the way pages are turned in a book.

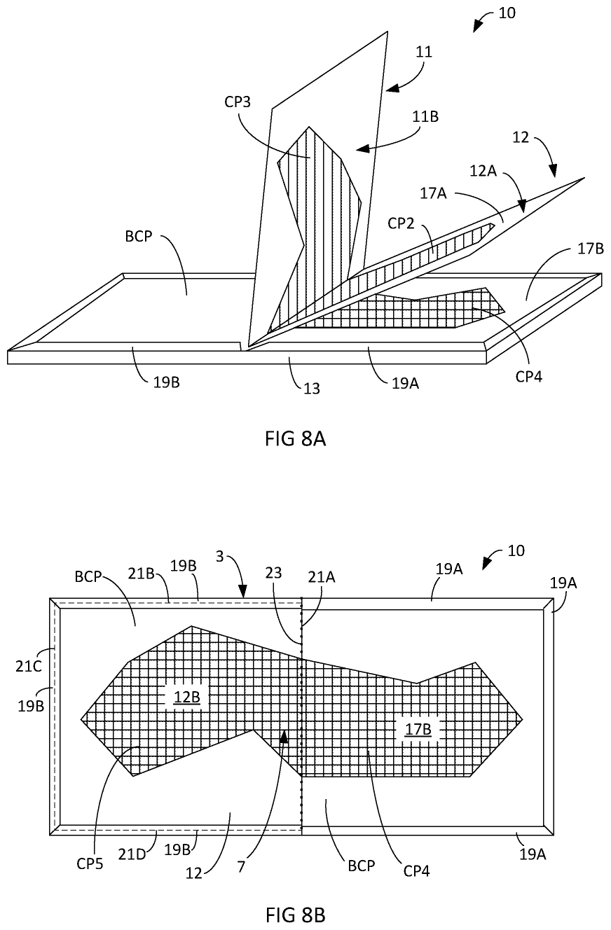

FIGS. 8A-8B illustrate an exemplary embodiment of a book-like multi-patch arrangement comprising a plurality of patches 11, 12 that can be folded or turned over, similar to the pages of a book, to cause the adaptive camouflage area 7 to exhibit various camouflage patterns or combinations of camouflage patterns.

With simultaneous reference to FIGS. 7A-7B′ this means that, in this embodiment, the concealable camouflage region underlying the first patch 11 when arranged in the first patch configuration is not a region of the base camouflage material 13 underlying the patch 11. Instead, this concealable camouflage region is a region of a first side 12A of a second patch 12, which second patch is covered and concealed by the first patch 11 when the first patch 11 is arranged in the first patch configuration (as illustrated in FIG. 7A), and revealed when the first patch 11 is moved into the second patch configuration (as illustrated in FIG. 7B). The first side 12A of the second patch 12 thus constitutes a first concealable camouflage region 17A that is provided with the second camouflage pattern CP2.

Just like the first patch 11, the second patch 12 can be moved between a first patch configuration in which it is securely maintained by the first set of releasable attachment means 19A, with the first side 12A of the second patch being exposed (corresponding to the first patch configuration of the first patch 11, illustrated in FIG. 7A), and a second patch configuration in which it is securely maintained by the second set of releasable attachment means 19B, with a second side 12B of the second patch being exposed (corresponding to the second patch configuration of the first patch 11 illustrated in FIG. 7B). The second patch 12 has substantially the same shape and size as the first patch 11 and may also be permanently attached to the base camouflage material 13 along a perimeter side of the second patch corresponding to the perimeter side 21A of the first patch 11. For example, the first patch 11 and the second 12 patch may be stitched to the base camouflage material 13 along corresponding perimeter sides. Once the first patch 11 has been moved into its second patch configuration by turning it over the permanently attached perimeter side 21A, the second patch 12 can be moved into its second patch configuration by turning it over its corresponding permanently attached perimeter side. When moving the second patch into the second patch configuration, a second concealable camouflage region 17B is revealed, which second concealable camouflage region may be located on a part of the base camouflage material 13 underlying the second patch 12 when arranged in the first patch configuration or, alternatively, on a first side of yet another patch in the book-like multi-patch arrangement.

The second concealable camouflage region 17B is provided with a fourth camouflage pattern CP4. The second side 12B of the second patch 12 is provided with a fifth camouflage pattern CP5 that is exposed next to the fourth camouflage pattern CP4 of the second concealable camouflage area 17B when the second patch 12 is arranged in the second patch configuration, as illustrated in FIG. 8B. The fourth camouflage pattern CP4 and the fifth camouflage pattern CP5 are typically chosen such that the combined effect of exposure of the fourth and fifth camouflage patterns on the overall camouflage pattern OCP is different than the combined effect of the exposure of the second CP2 and third CP3 camouflage pattern. In this way, the overall camouflage pattern OCM of the MCS 1 can be changed in different ways by moving either only the first patch 11 into its second patch configuration or by moving both the first 11 and the second patch 12 into their respective second patch configurations. Preferably, in order to change the camouflage pattern of the adaptive camouflage area 7 into any of two different and relatively large coherent camouflage patterns, the fourth camouflage pattern CP4 may correspond to the fifth camouflage pattern CP5, whereas the second camouflage pattern CP2 may correspond to the third camouflage pattern CP3, where the second CP2 and third CP3 camouflage patterns are different than the fourth CP4 and fifth CP5 camouflage patterns. This would allow the adaptive camouflage area 7 to exhibit any of the camouflage patterns illustrated in FIGS. 7A, 7B and 8B.

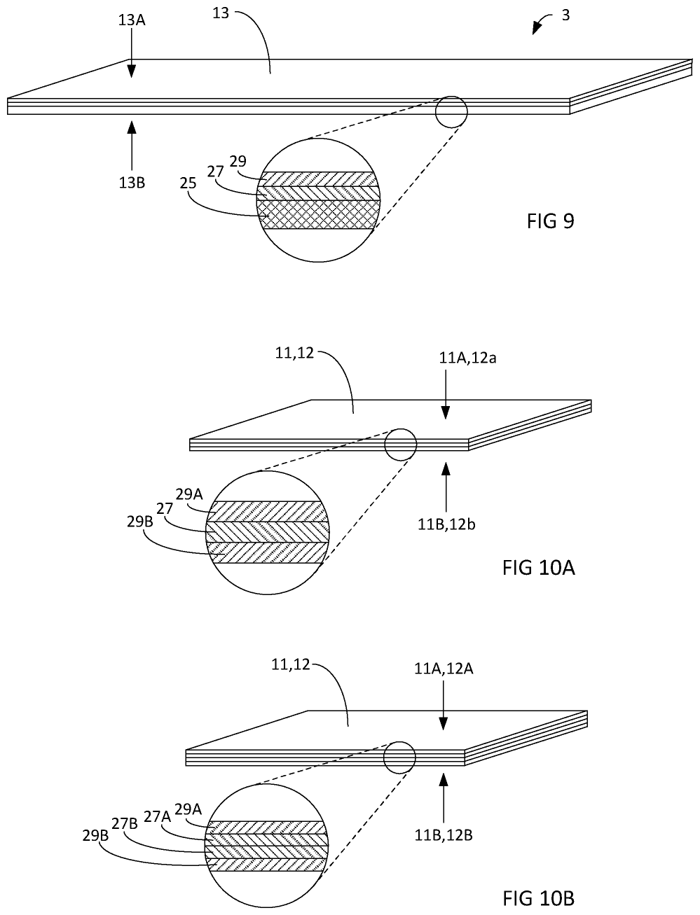

FIG. 9 illustrates a piece of the base camouflage material 13 of the MCS 1. The base camouflage material 13 is the main component of the MCS 1 and covers at least the majority portion of the camouflaged area of the vehicle 5. Typically, the base camouflage material is applied to substantially all visible, passive exterior areas of the vehicle 5. The base camouflage material 13 may thus constitute a base layer of the MCS 1.

In patch configurations in which the at least one patch 11, 12 of the adaptive camouflage areas 7 is attached to the base camouflage material 13, the patch is typically configured to overlie the base camouflage material. This means that the patch is arranged on the outer side of the base camouflage material 13 from the vehicle's point of view. At least the majority portion of the base camouflage material 13 is typically provided with a coherent camouflage pattern constituting the base camouflage pattern BCP of the MCS 1. This is typically the most dominant camouflage pattern of the MCS 1. Some regions of the base camouflage material 13, in particular regions constituting concealable camouflage regions 17 of adaptive camouflage areas 7 of the MCS 1, may be provided with a camouflage pattern that differs from the base camouflage pattern 13.

The non-adaptive camouflage areas 9 of the MCS 1 are typically constituted by areas of base camouflage material 13 that are not covered by a patch in any of the patch configurations. These areas of the base camouflage material 13 are typically provided with the base camouflage pattern BCP. Consequently, the base camouflage pattern BCP of the MCS 1 typically correspond to the camouflage pattern of the non-adaptive camouflage areas 9 of the base camouflage material 13.

When in use, i.e. when applied and securely attached to the vehicle 5, the base camouflage material 13 is fixed in relation to the vehicle. This means that the base camouflage material 13 constitutes a stationary base layer of the MCS 1 that cannot be moved in relation to the vehicle 5 during use.

As illustrated in FIG. 1, the MCS 1 may be a panel based MCS comprising a plurality of panels 3 that together constitutes the MCS. The piece of base camouflage material 13 illustrated in FIG. 9 is a panel 3 that forms a part of a non-adaptive camouflage area 9 of the MCS 1.

With reference now made to FIG. 9, the base camouflage material 13 comprises a first side 13A configured to face away from the vehicle 5 during use of the MCS 1, and a second side 13B configured to face the vehicle 5 during use of the MCS 1. The first side 13A of the base camouflage material 13 is configured to be exposed to an observer of the camouflaged vehicle 5. The first side 13A may hereinafter be referred to as the outer side of the base camouflage material 13 and the second side 13B may hereinafter be referred to as the inner side of the base camouflage material.

The base camouflage material 13 is a multi-layered camouflage material comprising a plurality of layers 25, 27, 29 providing protection in different parts of the electromagnetic spectrum.

The innermost layer of the base camouflage material 13 is a radar absorbing layer 25 configured to provide camouflage at least within parts of the radar wavelength region of the electromagnetic spectrum. This is achieved through absorption of electromagnetic radiation in at least parts of the radar frequency range of 1-100 GHz. The radar absorbing layer 25 is preferably configured to provide camouflage at least within parts of any or both of the X-band (8-12 GHz) and the K-band (12-40 GHz). Preferably, the radar absorbing layer 25 is also configured to provide camouflage within at least parts of the W-band (75-110 GHz). Most preferably, the radar absorbing layer 25 is a broadband radar absorbent configured to provide camouflage within at least parts of each of the X-band, K-band and W-band. In order to provide the desired radar camouflage, the radar absorbing layer 25 may comprise electrically conductive particles, such as carbon black. The electrically conductive particles may be comprised in a foam or fabric material, such as a polyolefin, polyester or polyurethane foam or fabric. The foam or fabric material may simultaneously serve as a supporting layer of the base camouflage material 13. An example of a material that may be used as radar absorbing layer 25 is disclosed in U.S. Pat. No. 4,064,305. Other radar absorbing materials that are suitable for use in the radar absorbing layer 25 may be provided e.g. by Laird Technologies.

The second layer arranged outside the radar absorbing layer 25 is a backing layer 27. The backing layer 27 is configured to provide camouflage at least within the electro-optical parts of the electromagnetic spectrum while serving as a backing of the outermost layer 29. The backing layer 27 is typically a continuous layer that is visually opaque. The backing layer 27 may in itself be formed as a multi-layered material. For example, the backing layer 27 may comprise a polymeric outer layer comprising one or more colourants selected to give the backing a desired colour. The polymeric layer may, for example, comprise a pigmented polyethylene film or a PVC coated fabric. The polymeric outer layer is preferably configured to be substantially transparent in radar wavelength regions and TIR wavelength regions, including the important MWIR and LWIR wavelength regions. The polymeric layer of the backing 27 may or may not comprise a metallic layer that is highly reflective in TIR wavelength regions. Such a metallic layer may be included in the backing 27 to reduce the thermal emissivity of the base camouflage material 13. The metallic layer may, for example, be provided as a metal film that is coated onto the inner surface of the polymeric layer, i.e. onto the surface of the polymeric layer that faces the radar absorbing layer 25. For example, the metallic layer may be provided in form of a vaporized aluminium coating, coated onto the polymeric layer. If so, the backing 27 forms a metalized, low-emissive polymeric film. In order to minimise radar reflection, the metallic layer may be crackled or broken up to form a mosaic structure. This type of low-emissive backing is particularly suitable for providing woodland camouflage and winter camouflage where there is a desire to reduce the apparent TIR signature of the vehicle 5. For efficient desert camouflage, however, the metallic layer is better left out to increase the thermal emissivity of the base camouflage material 13. Consequently, whether or not to include a metallic layer in the backing 27 of the base camouflage material typically depends on the temperature of the surrounding environment in geographical areas in which the vehicle 5 is intended to be used.

The third and outermost layer of the base camouflage material 13 is a garnish 29. The garnish 29 may be made from the same or similar material as the backing 27. Just like the backing, the garnish 29 may or may not comprise a metallic layer for reducing the thermal emissivity of the material. Consequently, the thermal emissivity of the base camouflage material 13 can be tailored to the surrounding environment in geographical areas in which the vehicle 5 is intended to be used by combining any of a low-emissivity backing and a high-emissivity backing with any of a low-emissivity garnish and a high-emissivity garnish. The garnish 29 may be incised or “leaf cut” to create a three dimensional (3D) leafy effect. Both the garnish 29 and the backing 27, which backing 27 may be partly visible through the incised garnish 29, are preferably provided with a matte (i.e. non-glossy) surface structure. The backing 27 and the garnish may be provided with the same colour or with different colours. Typically, the backing 27 and the garnish 29 is provided with the same or similar colours, or at least colours selected from a common colour scheme selected to provide camouflage within a specific terrain. For example, the backing 27 and the garnish 29 may be provided with one or more colours selected from one of a woodland landscape colour scheme, a winter landscape colour scheme, a desert landscape colour scheme, or a mountain landscape colour scheme. Appropriate colouration may be provided either throughout or on the exposed outer surface of the polymeric material of the backing 27 and the garnish 29.

The size of the panel 3 typically depends on the size, shape and contours of the vehicle 5. As illustrated in FIG. 1, the MCS 1 typically comprises panels 3 in different sizes and shapes. Typically, the area of the panel is 1 dm²-10 m², more typically 4 dm²-4 m², and most typically 5 dm²-3 m². The thickness of the panel 3 may also vary. In particular, the thickness of the panel 3 depends on whether or not a radar absorbing layer 25 is included in the base camouflage material 13. Typically, the material thickness of the panel 3 (i.e. the thickness of the panel when pressing the normally leaf-cut garnish 29 tight against the backing 27) is in the range of 3-20 mm, more typically 5-15 mm, and most typically 9-12 mm. The panel 3 is flexible in order to be bent around joints, edges and irregular surface areas of the vehicle 5. Preferably, although being flexible, the panel 3 is provided with a certain degree of rigidity in order to facilitate mounting and dismounting of the MCS 1, and to make the MCS 1 more robust. To this end, the radar absorbing material of the radar absorbing layer 25, or an additional and innermost supporting layer of the radar absorbing layer, may be configured to provide a certain degree of rigidity to the panel 3.

It should be noted that the base camouflage material 13 may comprise the above described layers no matter whether the base camouflage material 13 is provided in form of separate panels 3, a substantially continuous layer of material, or in any other form. It should also be appreciated that the base camouflage material 13 may be devised differently, and that it may comprise more or less layers than the exemplary layers described above. In all circumstances, the base camouflage material 13 is configured to provide camouflage in the VIS wavelength region. Preferably, the base camouflage material 13 is configured to provide camouflage also in the NIR, SWIR and TIR wavelength regions, and most preferably to provide camouflage also in the radar wavelength region.

The at least one patch 11, 12 of the patch arrangements 10 is also configured to provide camouflage at least in the VIS wavelength region. Preferably, the patch 11, 12 is configured to provide camouflage also in the NIR, SWIR and TIR wavelength regions. To this end, the patch 11, 12 comprises at least one layer of garnish, preferably an incised and non-glossy garnish that provides the patch with a surface structure similar to the surface structure of the base camouflage material 13. In some embodiments, the patch 11, 12 may consist of an incised garnish that is provided with different colours on the different sides of the garnish, thereby exhibiting a first camouflage pattern when the first side of the garnish is exposed and a second and different camouflage pattern when the second side of the patch is exposed. The garnish may also be configured to exhibit different camouflage patterns (i.e. electromagnetic signatures) in the thermal wavelength regions by including a metallic layer in the garnish. The garnish may be a multilayer material and the metallic layer can be arranged in the garnish such that the garnish exhibits low-emissive camouflage properties when one of the sides of the garnish is exposed, while exhibiting high-emissive camouflage properties when the other side of the garnish is exposed. For example, one side of the garnish may have colours selected from a woodland camouflage colour scheme and be provided with low-emissive properties in the thermal wavelength region, while the other side may have colours selected from a desert camouflage colour scheme and be provided with high-emissive properties in the thermal wavelength region.

Although the patch 11, 12 may consist of a single or multiple layers of garnish, the patch 11, 12 preferably comprises both backing and garnish in order to increase the robustness and improve the camouflage properties of the patch. The backing and garnish may be devised and configured in accordance with the backing 27 and the garnish 29 described above with reference to FIG. 9. In some embodiments, some of which will be described below, the patch 11, 12 may comprise more than one backing layer 27 and/or more than one layer of garnish 29.

It is also contemplated that the patch 11, 12 may consist of a single or multiple layers of a continuous and visually opaque material, such as the backing material 27 described above. Although normally desirable to include both backing 27 and garnish 29 in the patches 11, 12, it may sometimes be advantageous to exclude the garnish to optimize the camouflage for certain surroundings, such as certain types of winter landscapes.

FIGS. 10A and 10B illustrate exemplary patch structures of the at least one patch 11, 12 of the patch arrangement 10 in FIGS. 3A-8B. In the illustrated examples, reference is made to the first 11 and the second 12 patch of the patch arrangement 10 illustrated in FIGS. 8A-8B. However, the principles may apply to any patch in any of the exemplary patch arrangements 10 described herein.

In the first example, illustrated in FIG. 10A, the patch 11, 12 comprises a backing layer 27 that is interposed between a first layer of garnish 29A and a second layer of garnish 29B. The first garnish 29A is arranged on the first side 11A, 12A of the patch 11, 12 and is exposed when the patch 11, 12 is arranged in a first patch configuration. The second garnish 29B is arranged on the second side 11B, 12B of the patch 11, 12 and is exposed in patch configurations in which the second side of the patch is exposed to the surroundings. The first and second garnish layers 29A and 29B are provided with different colours. They may also be configured to provide different thermal camouflage. For example, the first garnish 29A may include a metallic layer for low thermal emissivity, whereas the second garnish 29B may be void of any metallic layer to provide for higher thermal emissivity when the second side 11B, 12B of the patch 11, 12 is exposed to the surroundings. The colour and the emissivity values of the respective garnish 29A, 29B may be adapted to different surrounding environments, such as a woodland landscape and a desert landscape, respectively.

Both the first 29A and the second garnish 29B may be incised to provide a leafy 3D effect. If so, the backing layer 27 may be visible through the leaf-cut garnish 29A, 29B no matter which side of the patch 11, 12 is exposed to the surroundings. Therefore, the different sides of the backing may be provided with different colours. For example, the side of the backing 27 facing the first garnish 29A may be coated with a colour that is selected in dependence of the first garnish 29A. Typically, the colour of the side of the backing 27 that faces the first garnish 29A and the colour of at least the side of the first garnish 29A that faces away from the backing are selected from a common colour scheme selected to provide camouflage within a specific terrain, such as a woodland camouflage colour scheme or a desert camouflage colour scheme. Likewise, the side of the backing 27 facing the second garnish 29B may be coated with a colour that is selected in dependence of the second garnish.

In the second example, illustrated in FIG. 10B, the patch 11, 12 comprises two backing layers 27A, 27B interposed between the first 29A and the second 29B garnish layers. A first backing layer 27A is provided with a colour and, optionally, a thermal emissivity that is selected in dependence of the first garnish 29A in order for the first garnish and the first backing to together provide a desired camouflage pattern when the patch 11, 12 is arranged in a first patch configuration in which the first side 11A, 12A of the patch is exposed. A second backing layer 27B is provided with a colour and, optionally, a thermal emissivity that is selected in dependence of the second garnish 29B in order for the second garnish and the second backing to together provide a desired camouflage patterns when the patch 11, 12 is arranged in another patch configuration in which the second side 11B, 12B of the patch is exposed.

Using a single backing layer 27, as illustrated in FIG. 10A, is advantageous in that the thickness and weight of the patch 11, 12 are somewhat reduced compared to the scenario illustrated in FIG. 10B where two layers of backing 27A, 27B are used. However, using two layers 27A, 27B of backing is advantageous in that the camouflage pattern of the at least one adaptive camouflage area 7 of the MCS 1 may be better optimized to different situations and terrains.

As mentioned above, the at least one patch 11, 12 of the patch arrangement 10 preferably comprises at least one backing layer and at least one layer of garnish. The at least one layer of backing and the at least one layer of garnish are typically arranged in relation to each other such that the continuous and opaque layer of backing underlies the opaque but incised layer of garnish in all patch configurations in which the patch 11, 12 is attached to the MCS 1. Taking into account also the layers of the base camouflage material 13 (see FIG. 9), this means that, in these patch configurations, there are typically two or more layers of garnish and two or more layers of backing arranged on top of each other. Sometimes, in particular when several layers include metallic layers for providing low-emissivity camouflage in some or all patch configurations, radar attenuation becomes a challenge. Therefore, it is contemplated that one or more layers of the patch 11, 12 may include radar absorbing material, such as electrically conductive fibres, in order to compensate for a potential increase in radar reflectivity.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” “comprising,” “includes” and/or “including” when used herein, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms used herein should be interpreted as having a meaning that is consistent with their meaning in the context of this specification and the relevant art and will not be interpreted in an idealized or overly formal sense unless expressly so defined herein.

The foregoing has described the principles, preferred embodiments and modes of operation of the present invention. However, the invention should be regarded as illustrative rather than restrictive, and not as being limited to the particular embodiments discussed above. The different features of the various embodiments of the invention can be combined in other combinations than those explicitly described. It should therefore be appreciated that variations may be made in those embodiments by those skilled in the art without departing from the scope of the present invention as defined by the following claims.

1. A mobile camouflage system (1) for camouflaging vehicles, comprising
a base camouflage material (13) configured to be securely attached to a vehicle (5) to be camouflaged, and
at least one adaptive camouflage area (7) having a camouflage pattern that can be adapted to a surrounding environment,
characterised in that the adaptive camouflage area (7) comprises a patch arrangement (10) comprising at least one patch (11, 12) that is repeatedly movable in relation to the base camouflage material (13) between a first patch configuration in which the adaptive camouflage area (7) exhibits a first camouflage pattern, and at least a second patch configuration in which the adaptive camouflage area (7) exhibits a second camouflage pattern that is different than the first camouflage pattern,
the at least one patch (11, 12) being configured to overlie and cover a concealable camouflage region (17) of the base camouflage material (13) when the patch (11, 12) is arranged in the first patch configuration, and to expose the concealable camouflage region (17) in the second patch configuration.

2. The mobile camouflage system (1) of claim 1, wherein the adaptive camouflage area (7) comprises at least one concealable camouflage region (17, 17A, 17B), the at least one patch (11, 12) being configured to conceal the concealable camouflage region in the first patch configuration, and to expose the concealable camouflage region in the second patch configuration.

3. The mobile camouflage system (1) of claim 2, wherein the at least one patch (11, 12) is configured to be attached to the base camouflage material (13) of the mobile camouflage system in both the first and the second patch configurations.

4. The mobile camouflage system (1) of claim 3, wherein the at least one patch (11, 12) is configured to be arranged adjacent to the concealable camouflage region (17, 17A, 17B) in the second patch configuration, with a side (11B, 12B) of the patch being concealed in the first patch configuration now being exposed.

5. The mobile camouflage system (1) of claim 4, wherein the at least one patch (11, 12) has a first side (11A, 12A) provided with a first camouflage pattern (CP1) and a second side (11B, 12B) provided with a second camouflage pattern (CP3) that is different than the first camouflage pattern (CP1), the first side (11A, 12A) of the patch being exposed in the first patch configuration and the second side (11B, 12B) of the patch being exposed in the second patch configuration.

6. The mobile camouflage system (1) of claim 5, wherein the first camouflage pattern (CP1) corresponds to a base camouflage pattern (BCP) of the mobile camouflage system.

7. The mobile camouflage system (1) of claim 5, wherein the concealable camouflage region (17) is provided with a third camouflage pattern (CP2), the second camouflage pattern (CP3) of the second side (11B, 12B) of the at least one patch (11, 12) corresponding to the third camouflage pattern (CP2) of the concealable camouflage region.

8. The mobile camouflage system (1) of claim 1, wherein the at least one patch (11, 12) is configured to be permanently attached to the base camouflage material (13).

9. The mobile camouflage system (1) of claim 8, wherein the at least one patch (11, 12) is configured to be permanently attached to the base camouflage material (13) along a first perimeter side (21A) of the patch, the patch being configured to be moved between the first and the second patch configurations by turning the patch over the first perimeter side (21A).

10. The mobile camouflage system (1) of claim 9, wherein the at least one patch (11, 12) has a regular shape whereas at least a second side (11B, 12B) of the patch that is concealed in the first patch configuration and exposed in the second patch configuration is provided with an irregular camouflage pattern (CP3) having a different shape than the patch.

11. The mobile camouflage system (1) of claim 9, wherein the at least one patch (11, 12) is configured to be releasably attached to the base camouflage material (13) along at least a second perimeter side (21B-21F) of the patch in both the first and the second patch configuration.

12. The mobile camouflage system (1) of claim 11, wherein the base camouflage material (13) comprises at least one flap (22) that is configured to cover a releasable attachment means (19A, 19B) for releasably attaching the patch (11, 12) to the base camouflage material (13) in any or both of the first and second patch configurations.

13. The mobile camouflage system (1) of claim 11, wherein the mobile camouflage system is a panel based system comprising a plurality of panels (3) together constituting the mobile camouflage system, the at least one patch (11, 12) being attached to one of the panels (3) and configured to have a size and a shape making the at least second perimeter side (21B-21F) of the patch substantially follow a perimeter side of the panel (3).

14. (canceled)

15. The mobile camouflage system (1) of claim 1, wherein the base camouflage material (13) is configured to cover substantially all passive and visible exterior surfaces of the vehicle (5).

16. The mobile camouflage system (1) of claim 1, wherein the base camouflage material (13), once applied to the vehicle (5), is configured to remain stationary in relation to the vehicle (5).

17. The mobile camouflage system (1) of claim 1, wherein the mobile camouflage system is a multi-spectral camouflage system configured to provide camouflage in at least two and preferably all wavelength regions selected from the group consisting of the visual wavelength region, the near infrared wavelength region, the shortwave infrared wavelength region, the thermal infrared wavelength region, and the radar wavelength region.

18. A vehicle (5), such as a military vehicle, comprising a mobile camouflage system (1) according to claim 1.
